(19) United States
(12) Patent Application Publication
(10) Pub. No.: US 2012/0149339 A1
(43) Pub. Date: Jun. 14, 2012

(54) Archiving Text Messages

(75) Inventors: Anantha Kalyan Kumar Mulampaka, Sunnyvale, CA (US); Suresh Kumar Batchu, Milpitas, CA (US); Gregory Christopher Gerard, Palo Alto, CA (US)

(73) Assignee: MobileIron, Inc., Mountain View, CA (US)

(21) Appl. No.: 12/965,718

(22) Filed: Dec. 10, 2010

(51) Int. Cl. H04W 4/12

(52) U.S. Cl. 455/412.1

(57) ABSTRACT

One embodiment of the present disclosure provides a method that includes receiving, by a device management system, data from a text message, the text message having been transmitted to or from a mobile device. The method also includes converting, by the device management system, the data from the text message into an electronic mail message. The method further includes transmitting, by the device management system, the electronic mail message to an archiving system.

### TECHNICAL FIELD

This disclosure relates generally to mobile devices and management systems and, more particularly, to archiving text messages transmitted to and from mobile devices using a mobile device management system.

### BACKGROUND

In a manner similar to personal computers and laptops, business enterprises increasingly rely on mobile and handheld devices. Indeed, the capabilities and uses of mobile devices have moved beyond voice communications and personal information management applications to a variety of communications- and business-related functions including email, browsing, instant messaging, enterprise applications, and video applications. For example, the functionality of many mobile devices have been extended to include cellular and wireless local area network (WLAN) communications interfaces, as well as virtual private network (VPN) and other client applications. Furthermore, mobile devices used in enterprises may also include enterprise applications used by employees in the field or otherwise.

Deployment, management and configuration of mobile and handheld devices in enterprise environments, however, present certain challenges. For example, the vast and constantly changing variety of mobile device types, functions and capabilities presents challenges to business enterprise compliance policies (e.g., policies designed for complying with various business related laws and regulations, such as those enacted by the U.S. Security and Exchange Commission (SEC)).

### BRIEF DESCRIPTION OF THE DRAWINGS

FIG. 1 illustrates an example mobile device management architecture according to an embodiment of the present disclosure.

FIG. 2 is a schematic diagram illustrating an example server system architecture.

FIG. 3 is a schematic diagram illustrating an example mobile device system architecture.

FIG. 4 provides an example mobile device software architecture.

FIG. 5 illustrates an example process for archiving text messages transmitted to or from a mobile device.

### DESCRIPTION OF EXAMPLE EMBODIMENTS

Particular embodiments of the present disclosure provide methods, apparatuses and systems directed to archiving text messages transmitted to or from mobile devices in an enterprise environment. In particular, the present disclosure may provide a method that includes receiving, by a device management system, data from a text message, the text message having been transmitted to or from a mobile device. The method also includes converting, by the device management system, the data from the text message into an electronic mail message. The method further includes transmitting, by the device management system, the electronic mail message to an archiving system.

In particular embodiments, a mobile device management system allows for archiving text messages (such as Short Message Service (SMS) text messages and Multimedia Messaging Service (MMS) text messages) transmitted to or from mobile devices in an enterprise environment. In some embodiments, data from a text message is received by the device management system, and then converted into an electronic mail message having any suitable protocol (such as Simple Mail Transfer Protocol (SMTP)). In particular embodiments, this may allow the data from the text message to be transmitted to an archiving system as an electronic mail message. Furthermore, the electronic mail message may include the email address (or any other suitable identifier) of the user of the mobile device that received or transmitted the text message. This may differ from typical deployments, where the only way to identify the ‘sender’ or ‘recipient’ of the message is based on the phone number. In contrast to such typical deployments, particular embodiments of the mobile device management system may allow employee registration information to be compared with the enterprise backend, in order to resolve the telephone number to the employee's name and then to the employee's email address. Accordingly, the archiving system may archive the text message (in electronic mail message form) based on the user, not just a phone number. This may allow the text message to be more conveniently archived and retrieved during a search, as opposed to having to archive and search for a text message based on a phone number (e.g., the standard identification of a text message).

In particular embodiments, each mobile device includes a control client application (hereinafter referred to as “control client”) that is configured to interact with the device management system over a network link. More particularly, the control client application is configured to receive data, commands, and other messages from the device management system via a network link, to synchronize the state of the mobile device with the corresponding device object stored at the device management database, and to selectively track and upload data over the network link to the device management system and database. In various embodiments, the control client logs man-machine interface (MMI) data, file system commands, and other data characterizing usage of, and/or the actions performed on, the mobile device. Some or all of the log data is provided to the device management application hosted on the device management server, which can synchronize a device object stored at the database with that of the mobile device, and vice versa.

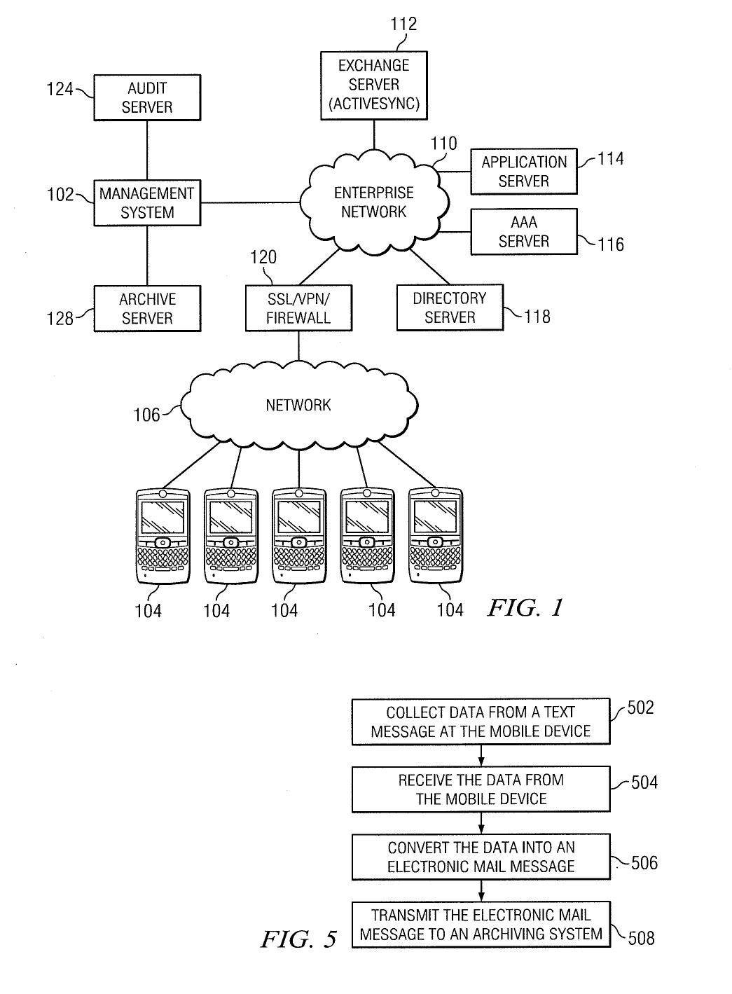

FIG. 1 illustrates a block diagram of a computer network environment 100 in accordance with an example embodiment. Computer network environment 100 includes a device management system 102 and a plurality of mobile devices 104 that may each communicate with device management system 102 via one or more network links 106. In various embodiments, device management system 102 may actually comprise one or more device management servers and device management databases, one or more of which may or may not be physically located within the physical boundaries of the enterprise.

Network link(s) 106 may include any suitable number or arrangement of interconnected networks including both wired and wireless networks. By way of example, a wireless communication network link over which mobile devices 104 communicate may utilize a cellular-based communication infrastructure that includes cellular-based communication protocols such as AMPS, CDMA, TDMA, GSM (Global System for Mobile communications), iDEN, GPRS, EDGE (Enhanced Data rates for GSM Evolution), UMTS (Universal Mobile Telecommunications System), WCDMA and their variants, among others. In various embodiments, network link 106 may further include, or alternately include, a variety of communication channels and networks such as WLAN/WiFi, WiMAX, Wide Area Networks (WANs), and BlueTooth.

As FIG. 1 illustrates, device management system 102 may be operably connected with (or included within) an enterprise network 110 (which may include or be a part of network link(s) 106). Enterprise network 110 may further include one or more of email or exchange servers 112, enterprise application servers 114, internal application store servers 122, authentication (AAA) servers 116, directory servers 118, Virtual Private Network (VPN)/SSL gateways 120, audit server 124, archive server 128, firewalls, among other servers and components. Email or exchange servers 112 may include Exchange ActiveSync (EAS) or other functionality that provides synchronization of contacts, calendars, tasks, and email between ActiveSync-enabled servers and mobile devices. Other synchronization protocols can also be used. The mobile devices 104 may access or utilize one or more of these enterprise systems or associated functionality.

In one embodiment, the audit server 124 may refer to any suitable system for performing an audit or storing information for the performance of an audit. In a further embodiment, the archive server 128 may refer to any suitable system for archiving information. In one embodiment, each of these servers may be coupled to the device management system 102 through a gateway, such as a VPN/SSL gateway, or through a secure SMTP connection. As such, the device management system 102 may transmit encrypted communications to the audit server 124 and the archive server 128. In particular embodiments, the communications may allow for archiving text messages transmitted to or from the mobile devices 104. In one embodiment, the audit server 124 and the archive server 128 may be archiving systems. An archiving system may be any type of storage device, such as a server, database, computer, or memory. In one embodiment, the archiving system may archive information, and further allow that information to be searched for and retrieved. Although the archiving systems have been described as including the audit server 124 and the archive server 128, in further embodiments, the archiving systems may include additional components or devices for archiving text messages, or may include entirely different components or devices for archiving text messages (e.g., such as an archive database, or any type of storage device). In a further embodiment, FIG. 1 may include only a single archiving system.

### Example System Architectures for Management System and Mobile Devices

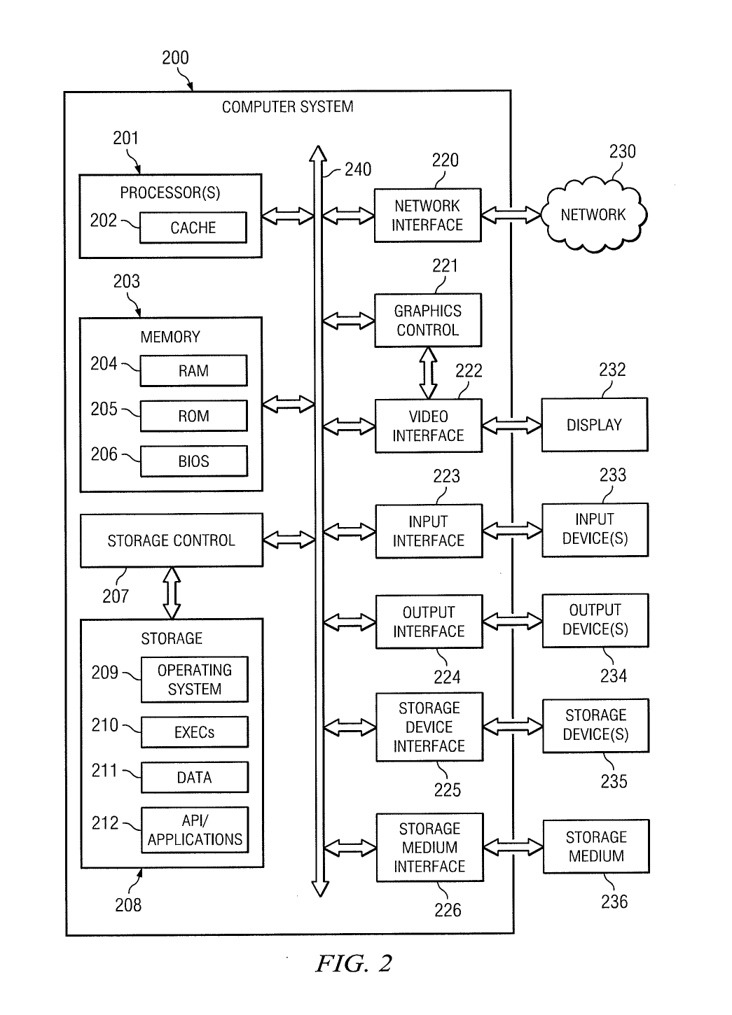

Management system 102 may actually include one or more hardware, firmware, and software components residing at one or more computer servers or systems (hereinafter referred to as computer systems). Software components of device management system 102 may be at one or more of the same computer systems. FIG. 2 illustrates an example computer system 200. Device management system 102 may include software components at one or more computer systems, which may be similar to example computer system 200. Particular embodiments may implement various functions of device management system 102 as hardware, software, or a combination of hardware and software. As an example and not by way of limitation, one or more computer systems may execute particular logic or software to perform one or more steps of one or more processes described or illustrated with respect to device management system 102. One or more of the computer systems may be unitary or distributed, spanning multiple computer systems or multiple datacenters, where appropriate. The present disclosure contemplates any suitable computer system. Herein, reference to logic may encompass software, and vice versa, where appropriate. Reference to software may encompass one or more computer programs, and vice versa, where appropriate. Reference to software may encompass data, instructions, or both, and vice versa, where appropriate. Similarly, reference to data may encompass instructions, and vice versa, where appropriate.

One or more tangible computer-readable media may store or otherwise embody software implementing particular embodiments. A tangible computer-readable medium may be any tangible medium capable of carrying, communicating, containing, holding, maintaining, propagating, retaining, storing, transmitting, transporting, or otherwise embodying software, where appropriate. A tangible computer-readable medium may be a biological, chemical, electronic, electromagnetic, infrared, magnetic, optical, quantum, or other suitable medium or a combination of two or more such media, where appropriate. A tangible computer-readable medium may include one or more nanometer-scale components or otherwise embody nanometer-scale design or fabrication. Example tangible, non-transitory computer-readable media include, but are not limited to, application-specific integrated circuits (ASICs), compact discs (CDs), field-programmable gate arrays (FPGAs), floppy disks, floptical disks, hard disks, holographic storage devices, magnetic tape, caches, programmable logic devices (PLDs), random-access memory (RAM) devices, read-only memory (ROM) devices, semiconductor memory devices, and other suitable computer-readable media.

Software implementing particular embodiments may be written in any suitable programming language (which may be procedural or object oriented) or combination of programming languages, where appropriate. Any suitable type of computer system (such as a single- or multiple-processor computer system) or systems may execute software implementing particular embodiments, where appropriate. A general-purpose or specific-purpose computer system may execute software implementing particular embodiments, where appropriate.

The components in FIG. 2 are examples only and do not limit the scope of use or functionality of any hardware, software, embedded logic component, or a combination of two or more such components implementing particular embodiments. Computer system 200 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers. Computer system 200 may include a display 232, one or more input devices 233 (which may, for example, include a keypad, a keyboard, a mouse, a stylus, etc.), one or more output devices 234, one or more storage devices 235, and various tangible storage media 236.

Bus 240 connects a wide variety of subsystems. Herein, reference to a bus may encompass one or more digital signal lines serving a common function, where appropriate. Bus 240 may be any of several types of bus structures including a memory bus, a peripheral bus, or a local bus using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, and an Accelerated Graphics Port (AGP) bus.

Processor(s) 201 (or central processing unit(s) (CPU(s))) optionally contains a cache memory unit 202 for temporary local storage of instructions, data, or computer addresses. Processor(s) 201 are coupled to tangible storage devices including memory 203. Memory 203 may include random access memory (RAM) 204 and read-only memory (ROM) 205. ROM 205 may act to communicate data and instructions unidirectionally to processor(s) 201, and RAM 704 may act to communicate data and instructions bidirectionally with processor(s) 201. ROM 205 and RAM 204 may include any suitable tangible computer-readable media described below. Fixed storage 208 is connected bidirectionally to processor(s) 201, optionally through storage control unit 207. Fixed storage 208 provides additional data storage capacity and may also include any suitable tangible computer-readable media described. Storage 208 may be used to store operating system 209, EXECs 210, data 211, application programs 212, and the like. Typically, storage 208 is a secondary storage medium (such as a hard disk) that is slower than primary storage. Information in storage 208 may, in appropriate cases, be incorporated as virtual memory in memory 203.

Processor(s) 201 is connected to multiple interfaces, such as graphics control 221, video interface 222, input interface 223, output interface 224, storage interface 225, and storage medium interface 226. These interfaces are in turn connected to appropriate devices, as may be illustrated. In general, an input/output (I/O) device may be a video display, a track ball, a mouse, a keyboard, a microphone, a touch-sensitive display, a transducer card reader, a magnetic- or paper- tape reader, a tablet, a stylus, a voice or handwriting recognizer, a biometrics reader, another computer system, or other suitable I/O device or a combination of two or more such I/O devices. Processor(s) 201 may connect to another computer system or to telecommunications network 230 (which may include network link 106 or enterprise network 110) through network interface 220. With network interface 220, CPU 201 may communicate with network 230 in the course of performing one or more steps of one or more processes described or illustrated herein, according to particular needs. Moreover, one or more steps of one or more processes described or illustrated herein may execute solely at CPU 201. In addition or as an alternative, one or more steps of one or more processes described or illustrated herein may execute at multiple CPUs 201 that are remote from each other across network 230.

In particular embodiments, when computer system 200 is connected to network 230, computer system 200 may communicate with other devices, specifically mobile devices 104 and enterprise systems, connected to network 230. Communications to and from computer system 200 may be sent through network interface 220. For example, network interface 220 may receive incoming communications (such as requests or responses from other devices) in the form of one or more packets (such as Internet Protocol (IP) packets) from network 230 and computer system 200 may store the incoming communications in memory 203 for processing. Computer system 200 may similarly store outgoing communications (such as requests or responses to other devices) in the form of one or more packets in memory 203 and communicated to network 230 from network interface 220. Processor(s) 201 may access these communication packets stored in memory 203 for processing.

Computer system 200 may provide functionality as a result of processor(s) 201 executing software embodied in one or more tangible computer-readable storage media, such as memory 203, storage 208, storage devices 235, and/or storage medium 236. The computer-readable media may store software that implements particular embodiments, and processor(s) 201 may execute the software. Memory 203 may read the software from one or more other computer-readable media (such as mass storage device(s) 235, 236) or from one or more other sources through a suitable interface, such as network interface 220. The software may cause processor(s) 201 to carry out one or more processes or one or more steps of one or more processes described or illustrated herein. Carrying out such processes or steps may include defining data structures stored in memory 203 and modifying the data structures as directed by the software. In addition or as an alternative, computer system 200 may provide functionality as a result of logic hardwired or otherwise embodied in a circuit, which may operate in place of or together with software to execute one or more processes or one or more steps of one or more processes described or illustrated herein. Herein, reference to software may encompass logic, and vice versa, where appropriate. Moreover, reference to a computer-readable medium may encompass a circuit (such as an IC) storing software for execution, a circuit embodying logic for execution, or both, where appropriate. The present disclosure encompasses any suitable combination of hardware, software, or both.

In particular embodiments, a mobile device 104 is a wireless phone such as a mobile or cellular phone. By way of example, mobile device 104 may be a smartphone (e.g., the iPhone or iPhone 3G manufactured by Apple Inc. of Cupertino, Calif., the BlackBerry manufactured by Research in Motion (RIM), the G1 based on the Android operating system, or Samsung BlackJack based on the Windows Mobile operating system), feature phone, basic cellular phone, personal digital assistant, or other multimedia device. Additionally, mobile device 104 may be affiliated with and supported by any suitable carrier or network service provider such as, by way of example, Sprint PCS, T-Mobile, Verizon, AT&T, or other suitable carrier.

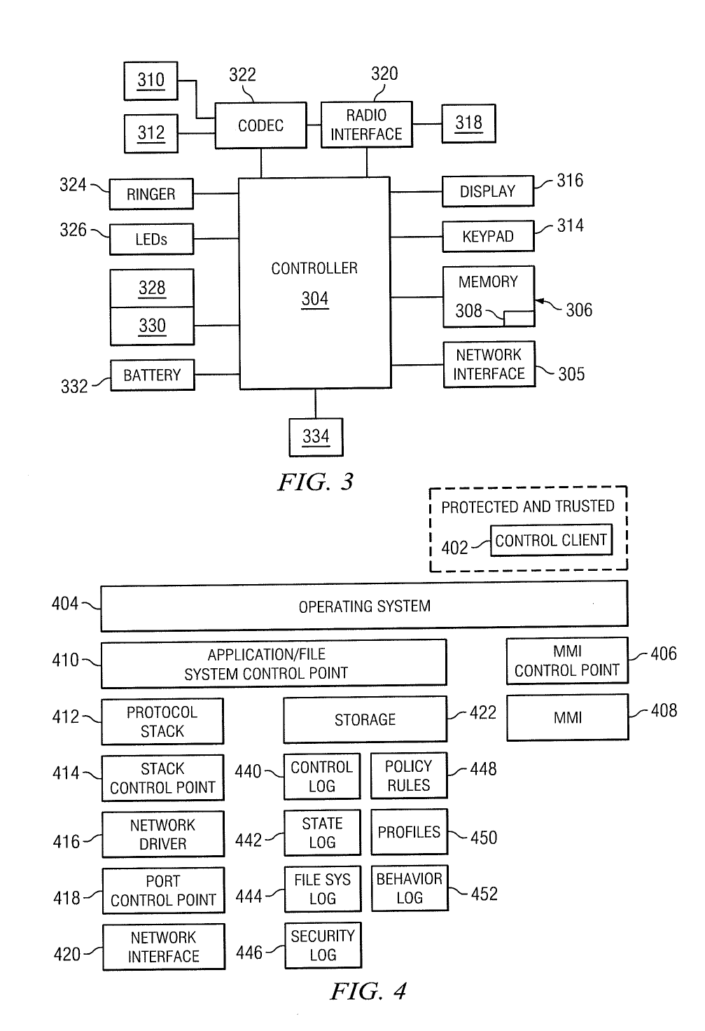

FIG. 3 shows a schematic representation of the main components of an example mobile device 104, according to various particular embodiments, which is adapted for use in connection with a GSM network or any other mobile telephone network as described above, and which may also be configured to meet the wireless application protocol specification (WAP). Mobile device 104 generally includes a controller 304 which may comprise a microcontroller or one or more processors configured to execute instructions and to carry out operations associated with mobile device 104. In various embodiments, controller 304 may be implemented as a single-chip, multiple chips and/or other electrical components including one or more integrated circuits and printed circuit boards. Controller 304 may optionally contain a cache memory unit for temporary local storage of instructions, data, or computer addresses. By way of example, using instructions retrieved from memory, controller 304 may control the reception and manipulation of input and output data between components of mobile device 104.

Controller 304 together with a suitable operating system may operate to execute instructions in the form of computer code and produce and use data. By way of example and not by way of limitation, the operating system may be Windows-based, Mac-based, or Unix or Linux-based, or Symbian-based, among other suitable operating systems. The operating system, other computer code (including control client 308 described below) and/or data may be physically stored within a memory block 306 that is operatively coupled to controller 304.

Memory block 306 encompasses one or more storage mediums and generally provides a place to store computer code (e.g., software and/or firmware) and data that are used by mobile device 104. By way of example, memory block 306 may include various tangible computer-readable storage media including Read-Only Memory (ROM) and/or Random-Access Memory (RAM). As is well known in the art, ROM acts to transfer data and instructions uni-directionally to controller 304, and RAM is used typically to transfer data and instructions in a bi-directional manner. Memory block 306 may also include one or more fixed storage devices in the form of, by way of example, solid-state hard disk drives (HDDs), among other suitable forms of memory coupled bi-directionally to controller 304. Information may also reside on a removable storage medium loaded into or installed in mobile device 104 when needed. By way of example, any of a number of suitable memory cards may be loaded into mobile device 104 on a temporary or permanent basis. By way of example, mobile device 104 may also include a subscriber identification module (SIM) card 328 and a SIM card reader 330.

Controller 304 is also generally coupled to a variety of interfaces such as graphics control, video interface, input interface, output interface, and storage interface, and these interfaces in turn are coupled to the appropriate devices. Controller 304 is also coupled to a network interface 305 that allows mobile device 104, and particularly controller 304, to be coupled to another computer (e.g., device management system 102) or telecommunications network (e.g., network link 106 or enterprise network 110). More particularly, network interface 305 generally allows controller 304 to receive information from network link 106, or might output information to the network link in the course of performing various method steps described below. Communications may be sent to and from mobile device 104 via network interface 305. By way of example, incoming communications, such as a request or a response from another device (e.g., device management system 102), in the form of one or more packets, may be received from network link 106 at network interface 305 and stored in selected sections in memory block 306 for processing. Outgoing communications, such as a request or a response to another device (e.g., device management system 102), again in the form of one or more packets, may also be stored in selected sections in memory 306 and sent out to network link 106 at network interface 305. Controller 304 may access these communication packets stored in memory 306 for processing.

Electric signals (e.g., analog) may be produced by microphone 310 and fed to earpiece 312. Controller 304 may receive instruction signals from keypad 314 (which may include soft keys) and control the operation of display 316 (In alternate embodiments, keypad 314 may be implemented as a virtual keypad displayed on display 316). By way of example, display 316 may incorporate liquid crystal display (LCD), light emitting diode (LED), Interferometric modulator display (IMOD), or any other suitable display technology. Radio signals may be transmitted and received by means of an antenna 318 that may be connected through a radio interface 320 to codec 322 configured to process signals under control of controller 304. Thus, in use for speech, codec 322 may receive signals (e.g., analog) from microphone 310, digitize them into a form suitable for transmission, and feed them to radio interface 320 for transmission through antenna 318 to, for example, a public land mobile network (PLMN). Similarly, received signals may be fed to codec 322 so as to produce signals (e.g., analog) which may be fed to ear piece 312. Mobile device 104 also generally includes a ringer (e.g., speaker) 324 and may also include light emitting diodes (LEDs) 326. In particular embodiments, mobile device 104 may be a dual mode phone having a wireless local area network (WLAN) interface, Worldwide Interoperability for Microwave Access (WiMAX) interface, and/or other wireless or physical interfaces (such as BlueTooth® and USB). Additionally, mobile device 104 may be powered by a removable battery pack 332.

Mobile device 104 may also include one or more user input devices 334 (other than keypad 314) that are operatively coupled to the controller 304. Generally, input devices 334 are configured to transfer data, commands and responses from the outside world into mobile device 108. By way of example, mobile device may include a joystick or directional pad. Input devices 334 may also include one or more hard buttons.

Display device 316 is generally configured to display a graphical user interface (GUI) that provides an easy to use visual interface between a user of the mobile device 104 and the operating system or application(s) running on the mobile device. Generally, the GUI presents programs, files and operational options with graphical images. During operation, the user may select and activate various graphical images displayed on the display 316 in order to initiate functions and tasks associated therewith.

In particular embodiments, each mobile device 104 includes a control client 308 that is configured to interact with the device management system 102 via network link 106. Control client 308 may generally be implemented as one or more software programs or applications stored in, by way of example, memory 306. Control client 308 is configured to receive data, commands, and other messages from the device management system 102 via network link 106, to synchronize the state of the mobile device 104 with a corresponding mobile device profile object stored at a device management database, and to selectively track and upload data over the network link to the device management system for logging by the device management system, as will be described in detail below. The logged data may include particular files (e.g., documents, spreadsheets, pdfs, pictures, etc.) stored in the mobile device as well particular application usage data in the form of, by way of example, activity data (e.g., data regarding calls, SMS or MMS messages, and email), content data (e.g., the text within the message or email body), and/or context data (e.g., timestamps and location data, etc.), as will be described in more detail below. In various embodiments, the control client logs man-machine interface (MMI) data, file system commands, and other data characterizing usage of, and/or the actions performed on, the mobile device. Some or all of the log data is provided to the device management application hosted on the device management system 102, which can synchronize a device object stored at the database with that of the mobile device, and vice versa.

In this manner, the device management system 102 may provide an administrator a detailed snapshot of the state of each mobile device 104, and facilitate device management operations. In particular, various embodiments enable selective erasing, tagging, copying, moving, modifying, viewing, and/or other selective action on or of particular data stored in a particular registered mobile device or designated group of mobile devices via the device management system 102.

In particular embodiments, device management system 102 is configured to selectively log data from each of the mobile devices 104 of an enterprise. More particularly, mobile device 104 may be configured to selectively track and/or log data and to upload this data to device management system 102 which, in turn, selectively logs or stores the data. In particular embodiments, each mobile device 104 is first registered with the device management system 102 by creating and storing a device object for the mobile device within the device management system 102. By way of example, an employee desiring to use a personally owned mobile device 104 may indicate to management that he or she desires to use the personally owned mobile device 104 with enterprise related services (e.g., email or access to an enterprise database) and needs enterprise access. Alternately, an employee receiving a mobile device 104 under a corporate liable plan may receive an enterprise owned mobile device 104 upon commencing employment or receiving a mobile device upgrade, by way of example. In particular embodiments, registering a mobile device 104 with the device management system 102 includes creating and storing a device object in a database within or connected with device management system 102. The device object may be implemented as part of a data structure corresponding to the particular mobile device 104. By way of example, a particular device object may include a device identifier that uniquely identifies the corresponding mobile device.

FIG. 4 illustrates how control client functionality may be integrated with mobile device 104. In particular embodiments, the control client functionality may include a control client application 402 and one or more control points inserted to monitor data traversing the interfaces of the mobile device 104. For example, a man-machine interface (MMI) control point 406 may be inserted into the driver stack of the man-machine interface 408 to log keystroke data. An application/file system control point 410 may be inserted to monitor and log application level and file system commands. Additionally, stack control point 414 may be inserted in one or more network protocol stacks of the mobile device 104, while port control points 418 may be inserted at a different layer of the network protocol stack. In various embodiments, one or more of the control points may be implemented as drivers that are installed in the appropriate driver stacks of the mobile device. In some embodiments, the control points may emulate the operation of higher layer and/or lower layer drivers and pass data on to the lower or higher layer native drivers. In some embodiments, a rule set may define what data is captured.

Control client application 402 may store the data collected by the control points in one or more log files stored on a storage device of the mobile device. For example, control client application 402 may store file system commands (such as open, save, delete, copy, rename, etc.) in file system log 344. Furthermore, control client application 402 may store keystroke data in behavior log 452. Still further, control client application 402 may store data relating to its own operation in control log 440.

The control client application 402 can provide some of all of the data to device management system 102, which may update one or more profile data objects that are associated with the mobile device 104 in a database. In this manner, a central device management system 102 can, for example, maintain an accurate image of the data storage device(s) of the mobile device 104, including the applications installed and the files stored on the mobile device. In various embodiments, control client application 402 may operate to provide this data in real- time, intermittently during periods of non-activity (e.g., such as when the mobile device is inserted into a charging cradle), in addition to, or at, periodic intervals. Still further, the data may be provided to the device management system 102 during a synchronization operation between the mobile device and the user's personal computer. In a particular embodiment, a synchronization utility hosted by the user's personal computer may be configured to transmit the data to the device management system 102. In addition, the control client application 402 may operate in one to a plurality of modes based on a set of rules or policies. Furthermore, the control client application 402 may also apply a rule set that determines what data is provided to the device management system 102, and/or when such data is transmitted.

In particular embodiments, the control client application 402 and the remote management server 102 may establish encrypted connections. For example, Virtual Private Network (VPN) tunneling and encryption may be used to secure the connection. In a particular embodiment, mobile device 104 may include port-based VPN functionality to encrypt the connection between the control client application 402 and the remote management server 102.

The control client functionality discussed above can be installed on a mobile device. For example, a mobile device without the control client functionality can be provisioned and configured as follows. In a preliminary step, an administrator may create a management instance of the mobile device with a minimal configuration. The mobile device 104, in some embodiments, may not be allowed access (or at least full access) to the enterprise's internal network, except for device registration and provisioning with the device management system 102. Suitable identifying information may include a device identifier, a user name, and the like. A user of the mobile device may then be directed to connect to the device management system 102 using, for example, a dial up connection, or a data connection with a WAP browser. The device management system 102, acting as an OMA DM server, may then interrogate the mobile device to learn one or more attributes (such as model number, serial number, operating system type and version, etc.), and provision and configure the mobile device. When the mobile device has been configured, the device management system 102 may further use the configuration and other information related to the mobile device to complete installation of a control agent on the mobile device and remove it from quarantine.

### Profile Data Objects for Users and Mobile Devices

Each user may be associated with a user profile object, which is a data object maintained in one or more data stores that includes various attributes of a user. In one embodiment, the user profile data may be maintained in a Lightweight Directory Access Protocol (LDAP) directory. In one embodiment, a user profile object may contain user identifying information such as full legal name, username (for login access to various systems), email address information, domain components (dc), telephone numbers, office locations, organizational information (such as department or group identifiers of an enterprise, reporting structure information, job title, etc.), authentication information, and mobile device profile information (or pointers to device profile data objects). A given user profile data object can include mobile device profile information for more than one mobile device 104. In addition, group or department objects can be configured to define one or more attributes that are common to a group or department within an enterprise, such as an engineering or sales department (enterprise-wide or regionally). Furthermore, some groups can be linked as sub-groups to other larger group designations. A user profile data object can be linked to one or more of these groups (either directly or by inheritance). For example, a salesperson may be linked to a “West Coast Sales Team Group,” which is a sub-group of a “Sales Division” of a given enterprise.

As discussed above, device management system 102 may maintain or access mobile device profile data objects for corresponding mobile devices 104 that have been registered. Mobile device profile information may include the make and model of the mobile device, an identifier of the operating system and version installed on the mobile device, serial numbers, Media Access Control (MAC) address (or other unique identifiers associated with one or more communications interfaces of the mobile device), and user profile information (or pointers to user profile data objects). Mobile device profile information may also include pointers to log data received from a control client 308 installed on a mobile device 104. Mobile device profile information may further include an image of the file system maintained on the mobile device 104, such as all applications and application files stored on the mobile device 104. This information may be made available to both users and network administrators for various purposes.

In particular embodiments, device management system 102 designates one or more group designations for the particular mobile device 104, or for the user of the mobile device 104. By way of example, device management system may present a user interface to an IT manager or administrator enabling the manager to enter designation information for each of a plurality of mobile devices. Device management system 102 then designates the one or more group designations with the mobile device by storing or otherwise associating the group designations with the device object within the database. By way of example, an IT manager may designate a particular mobile device 104 as being either personally owned or enterprise (company) owned. As another example, the IT manager may designate the mobile device 104 as being registered with an employee of a particular enterprise department (e.g., sales, marketing, research and development, management, human resources, accounting, etc.). As another example, the IT manager may designate the mobile device 104 as being registered with an employee of a particular class (e.g., management, staff, intern, new hire, etc.). As yet another example, a mobile device 104 may be designated based on the type (e.g., smartphone versus non-smartphone) or manufacturer (e.g., blackberry, apple) of the mobile device 104. In some embodiments, some or all of the group designations may be designated and stored automatically by device management system 102 based on mined information already stored in the database or other location.

### Data Logging

In particular embodiments, device management system 102 is configured to selectively log data from each of the mobile devices 104 of an enterprise. More particularly, mobile device 104 may be configured to selectively track and/or log data and to upload this data to device management system 102 which, in turn, selectively logs or stores the data.

In particular embodiments, only particular resources from the mobile device 104 are logged by device management system 102 and associated with the corresponding device object within device management system 102. By way of example, in particular embodiments, the data logging policies for a particular mobile device 104 (or particular group of mobile devices sharing one or more group designations) may cause device management system 102 to selectively log data corresponding to a particular file type (e.g., .doc, .xls, .jpeg, .mpeg, .pdf, .mp3, etc.). That is, device management system 102 may request client 308 to selectively track and upload these resources, and device management system 102 may selectively track and store the uploaded resources. Similarly, in particular embodiments, the data logging policies for a particular mobile device 104 may cause device management system 102 to selectively log data within one or more particular folders or directories.

As another example, in particular embodiments, the data logging policies for a particular mobile device 104 may cause device management system 102 to selectively log data corresponding to predetermined period of time (e.g., within the last week, within the last month, since the mobile device was registered, or within any selected time frame). As another example, in particular embodiments, the data logging policies for a particular mobile device 104 may cause device management system 102 to selectively log data corresponding to files stored in the mobile device (or modified in the mobile device) by the employee (e.g., pictures stored by the employee, documents stored by the employee, music stored by the employee, etc.). As yet another example, in particular embodiments, the data logging policies for a particular mobile device 104 may cause device management system 102 to selectively log data corresponding to files pre-tagged by an administrator. By way of example, client 308 may be configured to track resources pre-tagged or otherwise recognizable as confidential, enterprise-privileged, black-listed, restricted, regulatory, and those that contain customer data, etc.

In particular embodiments, the data logging policies for a particular mobile device 104 may cause device management system 102 to selectively log data corresponding to particular application usage data within device management system 102. By way of example, device management system 102 may include an application usage log for the mobile devices 104 registered with the enterprise. By way of example, in particular embodiments, the data logging policies for a particular mobile device 104 may cause device management system 102 to selectively log data corresponding to particular activity data. By way of example, the particular activity data may comprise voice (or call) usage information, SMS usage information (or other text message protocol information), or other data usage information (e.g., MMS or internet/web browser data usage). In particular, activity data may include the number of calls made by a particular user, the durations of such calls, and the identity of the user placing a particular call.

As another example, in particular embodiments, the data logging policies for a particular mobile device 104 may cause device management system 102 to selectively log data corresponding to particular context data corresponding to particular activity data. By way of example, context data may include information concerning the receiver of a particular call, whether the call was domestic versus international, the location of the user or receiver of the call at the time of the call (which may be determined using GPS, Cell ID, or other location detection technology and which may be incorporated into the corresponding mobile phone), the type of network used to make the call (e.g., 3G or 2G, as well as carrier), among other information.

Similar to voice usage, SMS, email, and other data usage may also be tracked and logged. By way of example, device management system 102 may log activity data such as the the MMS or SMS message sent or received, the number of SMS messages sent and/or received, the quantity (e.g., in kilobytes (kB) or megabytes (MB)) of data sent or received in each SMS message, as well as the quantity of data sent or received in an MMS message, email message, or from the internet in, for example, a mobile web browsing session. Device management system 102 may also log context data such as, by way of example, network information (e.g., 3G or 2G, as well as carrier), average or current network speed (e.g., kB/s or MB/s), and from whom, to whom, and when the data was sent, as well as where the transmitting and receiving parties are physically or geographically located. Regarding internet usage, device management system 102 may also log which websites a user navigates to as well as the duration and frequency of usage. Additionally, device management system 102 may also be configured to log which applications a user of a mobile device 104 uses, how frequently the user uses each application, which applications the user has downloaded, uploaded or otherwise installed, among other application data.

In particular embodiments, the data logging policies, as described above, may be implemented on an individual, group, department, or enterprise basis, among other divisions. Additionally, data logging policies may vary based on the type of usage (e.g., voice call, SMS, MMS, email, internet, etc.). Alternately, the data logging policies may cause particular email or text messages, including the content data, to be archived in the device management database. In particular embodiments, it is the responsibility of the enterprise network administrator to legislate the data logging policies even though it is device management system 102 that may implement the data logging policies. By way of example, as described above, an enterprise network administrator may choose different data logging policies for each mobile device 104 depending on the group designations associated with the particular mobile device.

Device management system 102 determines one or more data logging policies for each mobile device based on the group designations associated with each particular mobile device. By way of example, an enterprise manager or administrator may dictate particular policies and enter these policies into device management system 102. Afterwards, when group designations are matched to a particular mobile device 104, device management system may then, using the policies entered by the manager, automatically determine data logging policies for the mobile device 104. The data logging policies govern which data is logged (e.g., tracked and/or uploaded) from a particular mobile device to device management system 102. By way of example, a particular device object may be associated with one or more data logging policies stored within the database. Device management system 102 selectively logs (e.g., tracks and/or stores) data from the mobile devices 104 of the enterprise based on the data logging policies associated with each particular mobile device. For example, the device management system 102 may only log data (or even receive data from a mobile device 104) regarding text messages if that mobile device 104 is associated with a policy regarding archiving text messages (e.g., such as when that mobile device 104 is marked as being used by a user who falls under SEC compliance).

### Text Message Archiving

As is discussed above, business enterprises (e.g., Companies, Corporations, etc.) increasingly rely on mobile and hand-held devices. Such reliance is motivated, in part, by technological advances that have moved the capabilities and uses of mobile devices from voice communications and personal information management applications to a variety of communications- and business-related functions including email, browsing, messaging, enterprise applications, and video applications. Since business enterprises have increasingly turned to such mobile devices to conduct their business transactions, these business enterprises have also needed to change or modify their data retention policies to encompass data transmitted to and from the mobile devices so as to ensure that they remain in compliance with various laws and regulations (e.g., such as those enacted by the SEC).

In order to remain in compliance with such laws and regulations, business enterprises are already required to keep track of, save, and further archive various business-related communications (e.g., such as the SEC requirement to save certain business-related emails for a prescribed period of time). However, with a higher percentage of business functions being conducted on mobile devices through text messaging (e.g., such as SMS text messages and MMS text messages), it is becoming increasingly more important to keep track of, save, and archive such text messages for compliance and other purposes. Therefore, in order to assist with such a task, the device management system 102 may provide for tracking, saving, and archiving of text messages transmitted to and from a mobile device.

FIG. 5 shows a flow chart illustrating an example process for archiving text messages transmitted to or from a mobile device. In a particular embodiment, the data from a text message transmitted to or from a mobile device is collected (502) by the client (e.g., control client 308) in the background of the normal operations of the mobile device 104, such as by data logging, as is described above. In some embodiments, any and all of the data may be collected and transmitted by the mobile device on an event driven (e.g., such as upon receipt or transmittal of the text message, or upon opening of the text message) periodic, or continuous (e.g., whenever available) basis. In a further embodiment, the data may be collected and transmitted as frequently as possible while keeping power consumption associated with the collecting and transmitting below a power consumption threshold. In one embodiment, collecting the data may include correlating and packaging the data. Once the data is collected, a copy of the collected data may be stored in memory 306 within the mobile device 104 and, specifically, within various data storage logs such as, for example, a file system log, behavior log, control log, or in other call and data usage logs. Once the data from the text message is collected and a copy is stored, the data may be transmitted to the device management system 102.

After the data is transmitted, it is received at the device management system 102 from the mobile device 104 (504). The device management system 102 may then convert the data into an electronic mail message (506). In one embodiment, the electronic mail message may be an Simple Mail Transfer Protocol (SMTP) message. In a further embodiment, a copy of the electronic mail message may be stored at the device management system 102, or in a database coupled to the device management system 102. The electronic mail message may then be transmitted to an archiving system (508). In particular embodiments, the transmittal of the electronic mail message to the archiving system may be over a secure SMTP connection. As such, the electronic mail message may be encrypted.

As is discussed above, the data from the text message may be collected by the client 308 on the mobile device 104. In one embodiment, the text message may be intercepted at the protocol layer level by the client 308. As such, the text message may be intercepted as it is transmitted to or from the mobile device 104. In a further embodiment, the client 308 may monitor the text message inbox/outbox to determine whether a text message has been received or transmitted. Such monitoring may be conducted by polling the text message inbox/outbox periodically (e.g., such as every few milliseconds). As such, after the text message is posted to the text message inbox/outbox, the control client 308 may collect the data from the text message.

After the data from the text message is collected, a copy of the collected data may be stored in memory 306 within the mobile device 104. In one embodiment, the mobile device 104 may continue to store the copy of the data from the text message in memory 306 even if the user of the mobile device 104 deletes the text message from the text message inbox/outbox. In a further embodiment, the mobile device 104 may even continue to store the copy of the data from the text message even if the memory of the mobile device 104 is wiped (e.g., such as when the mobile device 104 is reported stolen, or an employee is terminated). In one embodiment, the mobile device 104 may continue to store the copy of the data from the text message in the memory 306 until the mobile device receives a receipt acknowledgement (ACK) from the device management system 102. For example, after the device management system 102 successfully receives the transmitted data from the text message, the device management system 102 may transmit the ACK to the mobile device 104, causing the mobile device 104 to delete the copy of the data. As such, the mobile device may not delete the copy of the data until the data has been successfully received by the device management system 102.

In one embodiment, the mobile device 104 (through the control client 308) may automatically transmit the data from the text message to the device management system 102 after collecting and storing the data. In a further embodiment, the mobile device 104 may only transmit the data from the text message to the device management system 102 after receiving a prompt from the device management system 102. For example, the device management system 102 may poll the mobile device 104 at periodic times in order to cause the mobile device 104 to transmit the data to the device management system 102.

In one embodiment, if the transmittal of the data from the text message has previously failed, the mobile device 104 may immediately attempt to re-transmit the data. For example, if the transmittal of a particular set of data fails, mobile device 104 may re-transmit the data as soon as (or immediately after) the mobile device 104 receives confirmation of the transmittal failure or after the mobile device 104 fails to receive a receipt acknowledgement from the device management system 102. As such, the mobile device 104 may not have to wait until the next transmittal period (e.g., when the data is transmitted on a periodic basis, when the mobile device 104 is prompted to transmit the data by the device management system 102, etc.) in order to re-transmit the data from the text message that was never received by the device management system 102.

After the device management system 102 has received the data from the text message, and converted the data from the text message into an electronic mail message, the device management system 102 may store a copy of the electronic mail message in storage until the device management system 102 receives a receipt acknowledgement (ACK) from the archiving system, or from a SMTP server that connects the device management system 102 to the archiving system. Once such an ACK is received, the device management system 102 may then delete the copy of the electronic mail message. As such, the device management system 102 may not delete the copy of the electronic mail message until the electronic mail message has been successfully received by the archiving system. In fact, the device management system 102 may continue to store the copy even if a hard failure occurs.

In one embodiment, the electronic mail message may be transmitted from the device management system 102 to the archiving system on an event driven, periodic or continuous (e.g., whenever available) basis. In a further embodiment, the device management system 102 may begin transmitting electronic mail messages to the archiving system once a sufficient number of the electronic mail messages have been queued. For example, a system administrator may set up the device management system 102 to begin transmitting the electronic mail messages once ten or more electronic mail messages have been queued. In a further embodiment, the electronic mail messages may be transmitted as frequently as possible while keeping power consumption associated with the transmitting below a power consumption threshold. In a further embodiment, the device management system 102 may provide a user interface to a system administrator in order to allow the system administrator to manually initiate the transmittal of the electronic mail messages to the archiving server. In such an example, the system administrator may manually initiate the transmittal of the electronic mail messages at any suitable time (e.g., such as after the device management system 102 alerts a system administrator that more than 100 electronic mail messages have been queued). In one embodiment, the user interface may further allow a system administrator to program when the device management system 102 transmits the electronic mail messages (e.g., such as every hour, every four hours, etc.).

In one embodiment, if a transmittal of an electronic mail message has previously failed, the device management system 102 may immediately attempt to re-transmit the electronic mail message. For example, if the transmittal of a particular electronic mail message fails, the device management system 102 may re-transmit the electronic mail message as soon as (or immediately after) the device management system 102 receives confirmation of the transmittal failure or after the device management system 102 fails to receive a receipt acknowledgement. As such, the device management system 102 may not have to wait until the next transmittal period (e.g., when the messages are transmitted on a periodic basis) in order to re-transmit an electronic mail message that was never received by the archiving system. In one embodiment, if the electronic mail message fails to transmit twice (or any other suitable number), the device management system 102 may provide an alert to a system administrator. In a further embodiment, the device management system 102 may further provide an alert to a system administrator any time a hard failure occurs, such as a hard failure that prevents any electronic mail messages from being transmitted.

In one embodiment, the device management system 102 may include a user interface that allows a system administrator to access any suitable information regarding the data from the text messages, the electronic mail messages, or the copies of the electronic mail messages. For example, the user interface may provide information regarding how many sets of data are queued for conversion to electronic mail messages, how many electronic mail messages are queued for transmittal, and how many copies of the electronic mail messages are currently being stored. In a further example, the user interface may allow the system administrator to access any of the data from the text messages (e.g., such as the content of any particular text message) or any of the data in the electronic mail messages or the copies of the electronic mail messages.

Converting the Data from the Text Message to an Electronic Mail Message

In order to archive the text messages transmitted to or from the mobile devices 104, the device management system 102 converts the data from the text message to an electronic mail message. In one embodiment, the data from the text message may include the following:
to phone number—the phone number of the mobile device that the text message is sent to
from phone number—the phone number of the mobile device that the text message is sent from
content of the text message—the actual content of the message (e.g., such as what the text message says)
timestamp—the date and time (down to seconds) of the text message.

The data from the text message may further include the direction of the text message (e.g., whether the text message was transmitted from the mobile device 104 (“outgoing”), or transmitted to the mobile device 104 (“incoming”)), the geographical location (e.g., “location”-stamp) of the mobile device at the time the text message was transmitted or received (e.g., obtained through GPS location data), the cellular tower used by the mobile device during the transmittal or receipt of the text message (or information that is usable in identifying the cellular tower), or any other suitable data from or about the text message.

As is discussed above, the data from the text message may include a timestamp. In one embodiment, the timestamp for a text message transmitted from the mobile device 104 may include the date and time when the text message was actually transmitted from the mobile device 104. Furthermore, the timestamp for a text message transmitted to the mobile device 104 (e.g., it is received by the mobile device 104) may include the date and time when the text message was collected by the control client 308, the date and time when the text message entered the text message inbox of the mobile device 104, the date and time when the text message was sent by another mobile device, or the date and time when the Carrier's SMS server delivered the text message. Additionally, this timestamp may be further converted to Universal Time. With regard to the received text message, in particular embodiments, by using a timestamp that is based on an action of control client 308 of the mobile device 104, the device management system 102 may not have to use any other timestamp that may be associated with the text message (e.g., such as a timestamp placed on the text message by one or more of the gateways that the text message was sent through before being received by the mobile device 104). In one embodiment, this may provide a further level of consistency.

After the device management system 102 receives the data from the text message from the mobile device 104, the device management system 102 may access the mobile device profile data object for that particular mobile device 104 (e.g., which was created when the mobile device 104 was registered with the device management system 102, as is discussed above). Such access may occur based on the phone number data from the text message, from identifying information associated with the transmission of the data from the mobile device 104 (e.g., the device management system 102 can determine the identity of the mobile device 104 that is communicating with the device management system 102), or based on any other suitable information. In one embodiment, as is discussed above, the mobile device profile data object may include the make and model of the mobile device, an identifier of the operating system and version installed in the mobile device, serial numbers, MAC address, and pointers to the user profile data object (or even user profile information). Based on these pointers, the device management system 102 may access the user profile data object in order to determine the identity of the user associated with the mobile device 104. In one embodiment, this may allow the device management system 102 to determine information about the user (and the mobile device 104) that transmitted or received each particular text message.

In one embodiment, the device management system 102 may access any of the data stored in the user profile data object. As is discussed above, the data in the user profile data object may include the full legal name, user name, email address information, domain components, telephone numbers, office locations, organizational information, authentication information, and mobile device profile information (or pointers to the mobile device profile data object). In one embodiment, the device management system 102 may access the user profile data object in order to retrieve some of the data, such as the user identification and the email address associated with the user of the mobile device 104. In further embodiments, the device management system 102 may retrieve any other suitable data from the user profile data object.

The device management system 102 may use the data from the text message and the data from the user profile data object (or even the data from the mobile device profile data object) in order to convert the data from the text message into an electronic mail message. In one embodiment, the data from the text message may be converted into an electronic mail message having any suitable protocol (such as SMTP). SMTP is a text-based protocol in which a mail sender communicates with a mail receiver by issuing command strings and supplying necessary data over a reliable ordered data stream channel, typically a Transmission Control Protocol (TCP) connection. Further information regarding SMTP may be found in the Network Working Group, Request for Comments: 5321, entitled “Simple Mail Transfer Protocol,” dated October 2008, and authored by J. Klensin, which is incorporated herein by reference. According to one embodiment, a SMTP electronic mail message may include the following fields:

MAIL FROM:

RCPT TO:

- - -

From:

To:

Subject:

Body:

In one embodiment, the “MAIL FROM:” field may be a command that notifies the receiver of the originating email address; the “RCPT TO:” field may be a command that includes the email address that the message is sent to; the “From:” field may include the originating email address of the message; the “To:” field may include the email address that the message is sent to; the “Subject:” field may include the subject of the electronic mail message (e.g., such as “Test Message E-mail;” and the “Body:” may include the content of the electronic mail message (e.g., such as “Test Message”).

The device management system 102 may convert the data from the text message into the SMTP electronic mail message by inserting the data (e.g., all of the data or only some of the data) from the text message into fields of the SMTP electronic message, and further inserting other information into the fields of the SMTP electronic mail message (e.g., such as data retrieved from the user profile data object, data retrieved from the mobile device profile data object, or any other suitable information).

The following may illustrate one example of a conversion of the data from a text message into an SMTP electronic mail message. In such an example, the data from the text message may include the following:

SMS log id (to uniquely identify SMS log): 2

to phone number: 18094523224

from phone number: 14083653463

content of the message: Test Message

timestamp: 2010-08-24T13:42:28+00:00

direction of the text message: outgoing (e.g., transmitted from the mobile device)

After the device management system 102 receives this data from the text message, the device management system 102 may access the user profile data object (such as by first accessing the mobile device profile data object) in order to retrieve the user's email address (User1@management.com). The device management system 102 may also retrieve (from a storage location) the email address of the archiving system(s) that the electronic mail message is transmitted to. For example, with regard to FIG. 1, the device management system 102 may include programming regarding the email address of the audit server 124 (audit@management.com) and the archive server 128 (archive@management.com) that the device managements system 102 is connected to. As such, the device management system 102 may further retrieve these email addresses, or email addresses that include these email addresses (e.g., such as with email distribution lists).

Once the device management system 102 has all of this data, it may then insert the data into the following fields of the SMTP electronic mail message (e.g., thus converting the data from the text message into the SMTP electronic mail message):

MAIL FROM: User1@management.com

RCPT TO: audit@management.com; archive@management.com

- - -

From: User1@management.com

To: audit@management.com; archive@management.com

Subject: From 14083653463 to 18094523224; incoming message; 2010-08-24T13:42:28+00:002351.38

Body: Test Message

As can be seen above, the “MAIL FROM:” and the “From:” fields of the SMTP electronic message include the email address of the user whose device sent/received the text message. The “RCPT TO:” and the “To:” fields of the SMTP electronic mail message include the email addresses of the archiving systems that will receive the electronic mail message. The “subject:” field of the SMTP electronic mail message includes the phone number of the mobile device that transmitted the text message and the phone number of the mobile device that received the text message, the direction of the text message, and the timestamp of the text message. (e.g., normalized to Coordinated Universal Time (UTC)). Finally, the body includes the content of the text message. In further embodiments, the electronic mail message may further include any suitable metadata. Such metadata may include further data from the text message, data from the user profile data object, data from the mobile device profile data object, or any other suitable data.

In further embodiments, the electronic mail message may be formatted in any other suitable way, and include any other suitable fields (e.g., such as “cc:” and “bcc:”). Furthermore, any other data may be inserted into each (or some) of the fields of the electronic mail message. For example, one or more of the fields may include the name of the user of the mobile device. As another example, the electronic mail message may include the following:

From: 14083653463@management.com

To: audit@management.com; archive@management.com

Subject: SMS message to 18094523224

Body: “Test Message”

In additional embodiments, the electronic mail components, fields, and/or format (or any other suitable aspect of the electronic mail message) may be configurable by an administrator to match an archival system's requirements. As such, the electronic mail message may be used with any archival system.

The electronic mail message may include a timestamp for the text message. In one embodiment, the device management system 102 may normalize the timestamp into a standard time (e.g., such as Coordinate Universal Time (UTC), Greenwich Mean Time (GMT), etc.) prior to inserting the timestamp into a field of the SMTP electronic mail message. By normalizing the timestamp, the device management system 102 may provide a more consistent timestamp. In particular, because the timestamp is normalized, the archiving system may not have to deal with different time zones. Thus, the archiving system (or a searcher of the archiving system) may not have to reorder the text messages based on the fact that one text message has a Eastern Daylight Time timestamp (for a text message that was transmitted from the mobile device while in New York) while another electronic mail message has a Pacific Daylight Time timestamp (for a text message that was transmitted from the mobile device while in California). Instead, the timestamp for each of the text messages is normalized to a standard time.

After the data from the text message is converted into an electronic mail message, the electronic mail message may be transmitted to the archiving system. In one embodiment, the conversion of the data from the text message to an electronic mail message may allow the archiving system to both receive the electronic mail message and further sort the electronic mail message into appropriate storage locations. For example, with regard to the above example where the text message was received at the mobile device of User1 of the management company, the archiving system may sort the electronic mail message into a storage location that is associated with User1. Accordingly, the archiving system may be searched for any text messages that were received or transmitted by User1. In order to do so, the searcher (or searching program) may only have to access the storage locations associated with User1. Once the searcher has accessed these storage locations, the searcher may be able to retrieve any of the text messages received or transmitted by User1. In one embodiment, the archiving system may support any suitable search format. For example, a searcher may be able to search for text messages received by User1 from phone number 14083653463 in-between 8:00 PM EDT on Apr. 2, 2006 through 7:00 AM EDT on May 1, 2007. As another example, a searcher may be able to search for text messages that include the term “top secret,” and that were received in-between 4:00 PM EDT on May 5, 2010 through 7:00 AM EDT on May 6, 2010. In one embodiment, the archiving system may further archive any other suitable information, such as emails and voicemails. As such, the emails (and voicemails) for User1 may be stored in the same (or an associated) storage location as the text messages for User1.

The present disclosure encompasses all changes, substitutions, variations, alterations, and modifications to the example embodiments described herein that a person having ordinary skill in the art would comprehend. Similarly, where appropriate, the appended claims encompass all changes, substitutions, variations, alterations, and modifications to the example embodiments described herein that a person having ordinary skill in the art would comprehend.

To aid the Patent Office and any readers of any patent issued on this application and interpreting the claims appended hereto, Applicants wish to note that they do not intend any of the appended claims to invoke Paragraph 6 of 35 U.S.C. §112 as it exists on the date of filing hereof unless “means for” or “step for” are used in the particular claim.

What is claimed is:

1. A method, comprising:
receiving, by a device management system, data from a text message, the text message having been transmitted to or from a mobile device;
converting, by the device management system, the data from the text message into an electronic mail message; and
transmitting, by the device management system, the electronic mail message to an archiving system.

2. The method of claim 1, wherein the electronic mail message has a Simple Mail Transfer Protocol (SMTP).

3. The method of claim 1, wherein the text message comprises a Short Message Service (SMS) text message.

4. The method of claim 1, wherein the text message comprises a Multimedia Messaging Service (MMS) text message.

5. The method of claim 1, further comprising:
prior to the transmittal of the electronic mail message, storing, by the device management system, a copy of the electronic mail message; and
deleting, by the device management system, the copy of the electronic mail message only after receiving an acknowledgement from the archiving system that the electronic mail message has been received by the archiving system.

6. The method of claim 1, wherein converting the data from the text message into the electronic mail message comprises:
accessing a profile associated with the mobile device;
retrieving an electronic mail address associated with the mobile device from the profile; and
inserting the electronic mail address into one or more fields of the electronic mail message.

7. The method of claim 1, wherein the data from the text message comprises a timestamp for the text message; and
wherein converting the data from the text message into the electronic mail message comprises:
normalizing the timestamp to a standard time; and
inserting the normalized timestamp into one or more fields of the electronic mail message.

8. The method of claim 1, wherein the data from the text message is received from a control agent installed on the mobile device; and wherein the method of claim 1 further comprises, after receiving the data from the text message, transmitting an acknowledgement to the control agent that the data from the text message was received by the device management system.

9. One or more computer-readable tangible storage media encoding software that is operable when executed to:
receive data from a text message, the text message having been transmitted to or from a mobile device;
convert the data from the text message into an electronic mail message; and
transmit the electronic mail message to an archiving system.

10. The media of claim 9, wherein the electronic mail message has a Simple Mail Transfer Protocol (SMTP).

11. The media of claim 9, wherein the text message comprises a Short Message Service (SMS) text message.

12. The media of claim 9, wherein the text message comprises a Multimedia Messaging Service (MMS) text message.

13. The media of claim 9, wherein the software is further operable when executed to:
store a copy of the electronic mail message prior to the transmittal of the electronic mail message; and
delete the copy of the electronic mail message only after receiving an acknowledgement from the archiving system that the electronic mail message has been received by the archiving system.

14. The media of claim 9, wherein the software operable when executed to convert the data from the text message into the electronic mail message comprises software operable when executed to:
access a profile associated with the mobile device;
retrieve an electronic mail address associated with the mobile device from the profile; and
insert the electronic mail address into one or more fields of the electronic mail message.

15. The media of claim 9, wherein the data from the text message comprises a timestamp for the text message; and
wherein the software operable when executed to convert the data from the text message into the electronic mail message comprises software operable when executed to:
normalize the timestamp to a standard time; and
insert the normalized timestamp into one or more fields of the electronic mail message.

16. The media of claim 9, wherein the data from the text message is received from a control agent installed on the mobile device; and
wherein, after receiving the data from the text message, the software is further operable when executed to transmit an acknowledgement to the control agent that the data from the text message was received by the device management system.

17. An apparatus comprising:
one or more processors; and
a memory coupled to the processors and tangibly storing one or more instructions, the processors operable when executing the instructions to:
receive data from a text message, the text message having been transmitted to or from a mobile device;
convert the data from the text message into an electronic mail message; and
transmit the electronic mail message to an archiving system.

18. The apparatus of claim 17, wherein the electronic mail message has a Simple Mail Transfer Protocol (SMTP).

19. The apparatus of claim 17, wherein the text message comprises a Short Message Service (SMS) text message.

20. The apparatus of claim 17, wherein the text message comprises a Multimedia Messaging Service (MMS) text message.

21. The apparatus of claim 17, wherein the processors are further operable when executing the instructions to:
store a copy of the electronic mail message prior to the transmittal of the electronic mail message; and
delete the copy of the electronic mail message only after receiving an acknowledgement from the archiving system that the electronic mail message has been received by the archiving system.

22. The apparatus of claim 17, wherein the processors operable when executing the instructions to convert the data from the text message into the electronic mail message comprise processors operable when executing the instructions to:
access a profile associated with the mobile device;
retrieve an electronic mail address associated with the mobile device from the profile; and
insert the electronic mail address into one or more fields of the electronic mail message.

23. The apparatus of claim 17, wherein the data from the text message comprises a timestamp for the text message; and
wherein the processors operable when executing the instructions to convert the data from the text message into the electronic mail message comprise processors operable when executing the instructions to:
normalize the timestamp to a standard time; and
insert the normalized timestamp into one or more fields of the electronic mail message.

24. The apparatus of claim 17, wherein the data from the text message is received from a control agent installed on the mobile device; and
wherein, after receiving the data from the text message, the processors are further operable when executing the instructions to transmit an acknowledgement to the control agent that the data from the text message was received by the device management system.
